(19) United States
(12) Patent Application Publication
(10) Pub. No.: US 2003/0234779 A1
(43) Pub. Date: Dec. 25, 2003

(54) Display apparatus with a storage unit mounted on a signal transmission component externally of a display device

(76) Inventor: Jui-Ming Wang, Chung Ho City (TW)

Correspondence Address: TROP PRUNER & HU, PC, 8554 KATY FREEWAY, SUITE 100, HOUSTON, TX, 77024, US

(21) Appl. No.: 10/177,406

(22) Filed: Jun. 21, 2002

(51) Int. Cl. G09G 5/00

(52) U.S. Cl. 345/211

(57) ABSTRACT

A display apparatus includes a display device and a signal transmission component. The signal transmission component includes a storage unit and a plurality of transmission routes. The storage unit stores display data channel information corresponding to the display device therein. The signal transmission component has a first end adapted to be coupled detachably to a display circuit and a second end coupled to the display device. A first portion of the transmission routes has one end connected electrically to the storage unit and the other end extending to the first end of the signal transmission component so that the display data channel information stored in the storage unit can be retrieved by the display circuit. A second portion of the transmission routes extends from the first end to the second end of the signal transmission component so as to permit signal transmission between the display circuit and the display device.

### BACKGROUND OF THE INVENTION

1. Field of the Invention

The invention relates to a display apparatus, more particularly to a display apparatus with a storage unit that is mounted on a signal transmission component externally of a display device.

2. Description of the Related Art

Presently, the primary communications interface between a display apparatus and a computer video card is the display data channel (DDC), which supports the plug-and-play function. The DDC standard was set up by the Video Electronic Standards Association (VESA) to define a series of digital signals transmitted by a display apparatus to a computer video card. The digital signals include basic product identification, basic parameters, display specifications, etc. When the computer video card receives these data, it will automatically process the information and render the optimum screen resolution for the display apparatus.

Since the DDC information includes identification data of the display apparatus, such as the manufacturer's name, product serial number, manufacturing date, etc, its content may vary among individual display apparatus. The DDC information is usually stored in a memory chip mounted inside the display apparatus. However, in consideration of certain factors, such as whether the display apparatus involved will pass quality control, the ex-factory date, etc., the DDC information cannot be finalized until production of the display apparatus has been completed, i.e. the assembly and quality control operations have been concluded. In view of the foregoing, almost all manufacturers currently provide the DDC information in two stages. First, a memory chip for storing the DDC information is mounted in every display apparatus during assembly. Then, after the assembly and quality control operations have been successfully concluded, the display apparatus are connected in sequence via a cable to a programming module for storing the DDC information in the memory chip. The cable is removed upon completion of the programming operation. The tasks of attaching and detaching the cable to the display apparatus and the actual programming operation are laborious and time consuming, and are often the cause of bottleneck in the manufacturing process.

Therefore, if memory chips can be programmed with the DDC information externally of the display apparatus beforehand, then they can be programmed simultaneously in batches using a set of programming modules instead of being individually programmed inside each display apparatus, thereby saving a lot of time in the process of programming the DDC information. Yet this measure results in another undesirable flaw. Particularly, if programmed memory chips are already mounted inside the display apparatus before quality inspection, and it turned out that there are defective display apparatus that must be discarded, an unfavorable situation will arise in that the DDC information of the display apparatus may no longer be in order, i.e. the product serial numbers are non-consecutive as a result of the discarded display apparatus. To avoid the aforesaid situation, the only alternative is to mount the programmed memory chips after inspection. This, however, involves the task of dismantling the housing of each display apparatus before the corresponding memory chip can be mounted. The dismantling process is tedious and time consuming, and the time saved by batch programming may be offset or even exceeded by the dismantling task. This is the reason why few manufacturers opt to use pre-programmed memory chips in the manufacture of the display apparatus.

Although the memory chip carrying the DDC information is assembled onto a circuit board of the display apparatus, in practice, the DDC information is only provided for use by the computer video card when tuning the display apparatus and is actually irrelevant to the basic functionality of the display apparatus. In other words, without a memory chip carrying the DDC information, the display apparatus can still function normally.

Therefore, as long as a memory chip carrying the DDC information can be electrically connected to a computer video card, it is desirable to find a way for mounting the memory chip externally of a display device such that memory chips can be programmed beforehand in batches and such that the housings of assembled and inspected display apparatus need not be dismantled when installing the programmed memory chips, thereby simplifying the manufacturing flow and reducing the manufacturing time.

### SUMMARY OF THE INVENTION

Therefore, the main object of the present invention is to provide a display apparatus that can overcome the aforesaid drawbacks associated with the prior art.

Accordingly, a display apparatus of this invention is adapted for use with a display circuit and comprises:

a display device for receiving and processing image signals from the display circuit and for rendering images thereon; and

a signal transmission component including a storage unit and a plurality of transmission routes, the signal transmission component having a first end adapted to be coupled detachably to the display circuit and a second end coupled to the display device, the storage unit storing display data channel information corresponding to the display device therein, a first portion of the transmission routes having one end connected electrically to the storage unit and the other end extending to the first end of the signal transmission component so that the display data channel information stored in the storage unit can be retrieved by the display circuit, a second portion of the transmission routes extending from the first end to the second end of the signal transmission component so as to permit signal transmission between the display circuit and the display device.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram showing a preferred embodiment of a display apparatus according to the present invention;

FIG. 2 is a schematic view showing the preferred embodiment of a display apparatus according to the present invention; and

FIG. 3 is a fragmentary schematic diagram of a signal transmission component of the preferred embodiment of a display apparatus according to the present invention.

### DETAILED DESCRIPTION OF THE PREFERRED EMBODIMENT

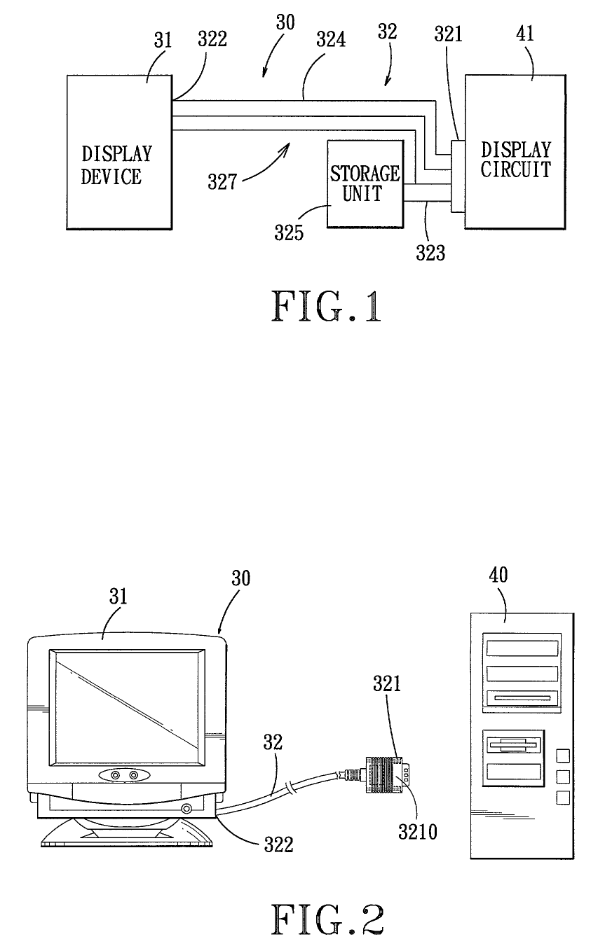

Referring to FIG. 1, the preferred embodiment of a display apparatus 30 according to this invention is adapted to receive external image signals from a device with a display circuit 41 that is capable of image signal processing, such as a computer 40 (see FIG. 2) with a computer video card (not shown) mounted therein. The display apparatus 30 comprises a display device 31 for receiving and processing the image signals from the display circuit 41 and for rendering images thereon in a known manner, and a signal transmission component 32, such as a signal cable that is electrically connected to the display device 31 and that is capable of transmitting the image signals from the display circuit 41 to the display device 31 and DDC information from the display apparatus 30 to the display circuit 41.

In view of the drawbacks of programming the DDC information into the assembled display device, and of installing a programmed memory chip that contains the DDC information into the assembled display device, the present invention contemplates installation of a programmed storage unit 325, such as a memory chip, that contains the DDC information externally of the display device 31. To this end, it is noted that the signal transmission component 32 is usually coupled to the display device 31 in the final stage of the manufacturing process. Therefore, the present invention teaches the integration of the storage unit 325 into the signal transmission component 32 in lieu of the display device 31 to overcome the drawbacks of the prior art.

As best shown in FIG. 1, a first end 321 of the signal transmission component 32 of the preferred embodiment of a display apparatus 30 according to this invention is detachably coupled to the display circuit 41, whereas a second end 322 of the signal transmission component 32 is coupled to the display device 31. The signal transmission component 32 includes a transmission route group 327 and the storage unit 325 that contains the DDC information corresponding to the display device 31. In order to enable the display circuit 41 to retrieve the DDC information stored in the storage unit 325, the transmission route group 327 includes a set of first transmission routes 323, each having one end connected electrically to the storage unit 325 and the other end extending to the first end 321 of the signal transmission component 32. Furthermore, in order to permit signal transmission between the display device 31 and the display circuit 41, the transmission route group 327 further includes a set of second transmission routes 324, each extending from the first end 321 to the second end 322 of the signal transmission component 32.

There are four DDC standards currently available: DDC1, DDC2B, DDC2B+ and DDC2AB. It is noted that the number and individual functions of the first transmission routes 323 may vary slightly according to the DDC standard that is in use. Furthermore, the first end 321 of the signal transmission component 32 is usually terminated by an electrical connector 3210 that can be plugged to the display circuit 41. The electrical connector 3210 may be a Mini-D-Sub connector having fifteen pins arranged in three rows, a D-Sub connector having fifteen pins arranged in two rows, a BNC connector (used in PS/2, Power MAC, WS), a universal serial bus (USB) connector, etc.

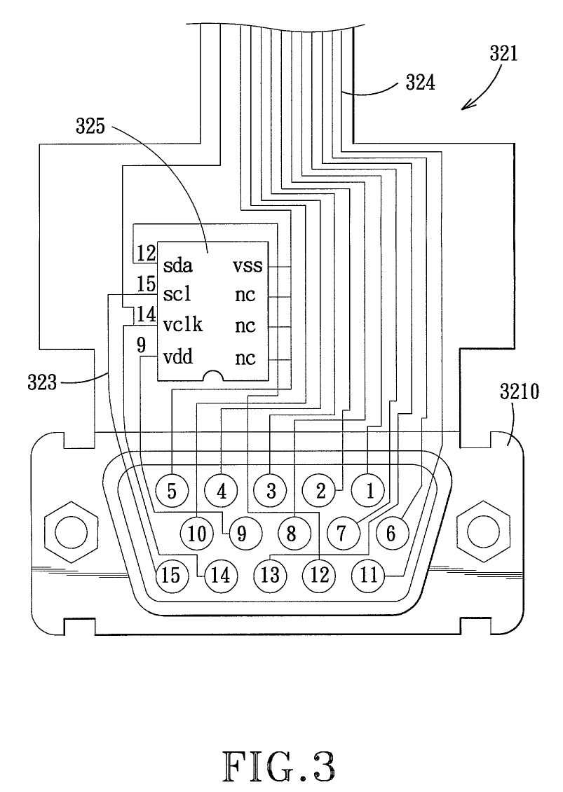

Referring further to FIG. 3, the display apparatus 30 of this invention is exemplified as one that adopts the DDC1 standard, and that includes a Mini-D-Sub electrical connector 3210 that terminates the first end 321 of the signal transmission component 32 and that is provided with fifteen conductive terminals, each of which is connected to a respective one of the transmission routes 323, 324. The storage unit 325 is in the form of 8-pin memory chip. The pin configuration of the electrical connector 3210 is shown in the following table:

| Pin | Function |
|---|---|
| 1 | Red signal |
| 2 | Green signal |
| 3 | Blue signal |
| 4 | No connection |
| 5 | No connection |
| 6 | Red signal grounding |
| 7 | Green signal grounding |
| 8 | Blue signal grounding |
| 9 | VS =+ 5 power supply |
| 10 | No connection |
| 11 | Ground |
| 12 | SDA (for plug-and-play) |
| 13 | Horizontal sync |
| 14 | Vertical sync & P&P |
| 15 | SCL (for P&P sync) |

According to the DDC1 standard, data signals are transmitted using two data and timing transmission routes, and vertical synchronization signals are also required. As shown in the above table, pins 12, 14 and 15 are relevant to the DDC1 standard, wherein pin 12 (SDA) is used to transmit the DDC information, such as manufacturer's name, product model name, serial number, screen resolution, etc., of the display apparatus 30. Pin 14 (VSYNC) is used to transmit vertical synchronization signals. Pin 15 (SCL) is used to transmit DDC timing pulse signals. Therefore, the storage unit 325 of this embodiment has three terminals sda, vclk and scl corresponding and connected to pins 12, 14 and 15 of the electrical connector 3210. Furthermore, when the electrical connector 3210 is plugged to the display circuit 41, pin 9 (VS) will be fed with +5V from the display circuit 41. Since the terminal vdd of the storage unit 325 is electrically connected to pin 9 (VS) of the electrical connector 3210, the storage unit 325 can thus receive power from the display circuit 41. Therefore, when the first end 321 of the signal transmission component 32 is electrically connected to the display circuit 41, through the first transmission routes 323, the display circuit 41 can provide power to the storage unit 325 via pin 9 (VS), and can retrieve the DDC information from the storage unit 325 via pins 12 (SDA) and 15 (SCL).

Moreover, as shown in the above table, pins 1, 2, 3, 6, 7, 8, 11, 13 and 14 of the electrical connector 321 correspond to the second transmission routes 324 for transmitting image signals from the display circuit 41 to the display device 31 via the signal transmission component 32. Note that pin 14 (VSYNC) is shared by both the first and second transmission routes 323, 324 as it is electrically connected to both the storage unit 325 and the display device 31. The pins of the electrical connector 3210 and the terminals of the storage unit 325 that are not in use may be connected to any one of pins 6, 7, 8 and 11 of the electrical connector 3210 so as to ground the same. In actual practice, power may be provided to the storage unit 325 by the display device 31 instead of the display circuit 41. Moreover, when the DDC standard used by the display apparatus 30 is other than the DDC1 standard, such as the DDC2B standard, the DDC signals are still transmitted using two data and timing transmission routes, but vertical synchronization signals are not required. It is thus apparent from the foregoing that the present invention can be applied to different DDC standards and can use different types of electrical connectors 3210.

When the present invention is applied to the manufacture of a specific batch of display apparatus 30, display devices 31 and signal transmission components 32 integrated with programmed storage units 325 that contain the DDC information can be separately manufactured in batch. Then, for those display devices 31 that passed inspection, the corresponding signal transmission component 32 can be secured thereto. As compared to the aforementioned prior art, programming of the storage units 325 can be quickly and conveniently conducted in the present invention. Moreover, the signal transmission components 32 and the display devices 31 can be simultaneously manufactured in the present invention. It is therefore apparent that the present invention can reduce production time and can thus overcomes the aforesaid drawbacks of the prior art.

It should be also noted that, although the storage unit 325 containing the DDC information is directly mounted to the signal transmission component 32 in the foregoing embodiment, the main essence of this invention resides in the provision of the storage unit 325 externally of the display device 31. It is not essential to integrate the storage unit 325 into the signal transmission component 32. For instance, the storage unit 325 can be mounted in an adaptor connected between the second end 322 of the signal transmission component 32 and the display device 31.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A display apparatus adapted for use with a display circuit, said display apparatus comprising:
a display device for receiving and processing image signals from the display circuit and for rendering images thereon; and
a signal transmission component including a storage unit and a plurality of transmission routes, said signal transmission component having a first end adapted to be coupled detachably to the display circuit and a second end coupled to said display device, said storage unit storing display data channel information corresponding to said display device therein, a first portion of said transmission routes having one end connected electrically to said storage unit and the other end extending to said first end of said signal transmission component so that the display data channel information stored in said storage unit can be retrieved by the display circuit, a second portion of said transmission routes extending from said first end to said second end of said signal transmission component so as to permit signal transmission between the display circuit and said display device.

2. The display apparatus as claimed in claim 1, wherein said storage unit is a memory chip.

3. The display apparatus as claimed in claim 1, wherein said first end of said signal transmission component is provided with a plurality of conductive terminals, each of which is connected to a respective one of said transmission routes.

4. The display apparatus as claimed in claim 1, wherein said first end of said signal transmission component is terminated by an electrical connector that is adapted to be plugged to the display circuit.

5. The display apparatus as claimed in claim 4, wherein said electrical connector is provided with a plurality of conductive terminals, each of which is connected to a respective one of said transmission routes.
